(19) United States
(12) Patent Application Publication
(10) Pub. No.: US 2025/0223197 A1
(43) Pub. Date: Jul. 10, 2025

(54) WATER TREATMENT SYSTEM

(71) Applicant: SK INNOVATION CO., LTD., Seoul (KR)

(72) Inventors: Yeon Hwa LA, Daejeon (KR); Jae Yang SONG, Daejeon (KR); Chung Seop LEE, Daejeon (KR); Hye Lin ROH, Daejeon (KR)

(21) Appl. No.: 19/012,885

(22) Filed: Jan. 8, 2025

(30) Foreign Application Priority Data
Jan. 8, 2024 (KR) 10-2024-0002976

(51) Int. Cl. C02F 1/24; B01F 23/23; B01F 23/231; B01F 101/00

(52) U.S. Cl. CPC C02F 1/24; B01F 23/2312; B01F 23/2319; B01F 2101/305

(57) ABSTRACT

The embodiments of this disclosure are related to a water treatment system comprising a flotation tank, a shell-tube inlet conduit connected to the flotation tank and comprising a shell configured to supply a gas and at least one tube configured to supply untreated water, wherein each of the shell and the tube has a first part exposed to an outside of the flotation tank and a second part extending into the flotation tank, a microbubble forming means positioned on or adjacent to the second part of the shell, and a treated water outlet connected to the flotation tank and configured to allow treated water separated from solids in the flotation tank to be discharged therethrough.

### CROSS REFERENCE TO RELATED APPLICATION

The present application claims priority to Korean Patent Application No. 10-2024-0002976, filed Jan. 8, 2024, the entire contents of which are incorporated herein by reference for all purposes.

### BACKGROUND

### Field of the Invention

Embodiments of the present disclosure relate generally to water treatment technology and, more particularly to a water treatment system comprising a flotation tank.

### Description of the Related Art

Wastewater is water that cannot be used as it is due to the liquid or solid water contaminants thereof. Wastewater includes domestic sewage, laundry wastewater, industrial wastewater, and agricultural/livestock wastewater in a broad sense.

Wastewater treatment is a process of removing adverse effects on rivers or seas into which wastewater flows by removing contaminants contained in wastewater or removing harmful effects. Wastewater treatment methods include physical treatment such as screening, filtration, precipitation, distillation, evaporation, and magnetic water treatment; and chemical treatment such as neutralization, oxidation-reduction, decomposition, coagulation, adsorption, flotation, extraction, ion exchange, stripping, and combustion/incineration. In addition, there are aerobic biological treatments such as an activated sludge method, a trickling filter method, an oxidation pond method, a rotating disk method, and a catalytic oxidation method, and anaerobic biological treatments such as a digestion method (a methane fermentation method) and a septic tank.

### SUMMARY

Embodiments of the present disclosure relate to a water treatment system.

According to an embodiment of the present disclosure, there is provided a water treatment system, comprising a flotation tank; a shell-tube inlet conduit connected to the flotation tank and comprising a shell configured to supply a gas and at least one tube configured to supply untreated water, in which each of the shell and the tube has a first part exposed to an outside of the flotation tank and a second part extending into the flotation tank; a microbubble forming means positioned on or adjacent to the second part of the shell; and a treated water outlet connected to the flotation tank and configured to allow treated water separated from solids in the flotation tank to be discharged therethrough.

In an embodiment, the flotation tank may have a predetermined height, the shell-tube inlet conduit may be connected to a lower part of the flotation tank, and the second part of each of the shell and the tube may extend from a bottom of the flotation tank to a position corresponding to at least 25% from the bottom of the height of the flotation tank.

In an embodiment, the at least one tube may be single tube.

In an embodiment, the shell-tube inlet conduit may further comprise a support installed between the shell and the at least one tube and configured to hold the at least one tube and maintain a separation distance therebetween.

In an embodiment, a ratio of a diameter of the second part of the tube to a diameter of the second part of the shell may be in a range of 1:1.1 to 1:3.

In an embodiment, wherein the position of the second end of the tube is higher than that of the second end of the shell.

In an embodiment, wherein the microbubble forming means is positioned on the second part of the shell or adjacent to the second part of the shell.

In an embodiment, the microbubble forming means may comprise a membrane diffuser, an electroflotation device, a shear flotation (SF) device, a pressurized flotation device, or a combination thereof.

In an embodiment, the treated water outlet may be formed at a position lower than the second end of the shell, the second end of the tube, or the microbubble forming means.

In an embodiment, the water treatment system may further comprise a floating solid recovery means.

According to another embodiment of the present disclosure, there is provided a method to treat water using the water treatment system.

In an embodiment, the method may comprise introducing untreated water into the flotation tank through the tube; supplying gas through the shell from the outside into the flotation tank; forming microbubbles by passing the gas through the microbubble forming means; and discharging the treated water to the outside of the flotation tank.

In an embodiment, a ratio of an inflow rate of the untreated water to an inflow rate of the gas may be in a range of 1:1 to 6:1.

In an embodiment, a size of microbubbles formed from the microbubble forming means may be equal to or less than 100 μm.

In an embodiment, an outflow rate of the treated water discharged through the treated water outlet may be equal to or less than an inflow rate of the untreated water introduced through the tube.

In an embodiment, it is possible to form bubbles with a long lifespan and a slow rising speed. In an embodiment, it is possible to suppress generation of a turbulent flow caused by bubbles. In an embodiment, it is possible to increase the adsorption rate between particles and bubbles. In an embodiment, it is possible to increase the flotation efficiency of particles in a water system.

### BRIEF DESCRIPTION OF THE DRAWINGS

FIG. 1 is a schematic view illustrating a water treatment system according to an embodiment of the present disclosure.

FIG. 2 is a schematic view illustrating a water treatment system according to another embodiment of the present disclosure.

### DETAILED DESCRIPTION

Hereinafter, the embodiments of the present disclosure will be described in detail with reference to the accompanying drawings. While the present invention may be embodied in many different forms, disclosed herein are specific embodiments thereof that illustrate the principles of the present disclosure. It should be emphasized that the embodiments of the present disclosure are not limited to the specific embodiments illustrated.

### Water Treatment System

An embodiment of the present disclosure provides a water treatment system. Untreated water, such as wastewater, is introduced into the water treatment system. The untreated water is separated into solids and treated water in a flotation tank, and these may be recovered separately.

In the present disclosure, “untreated water” refers to water in which solids and water are mixed, and is not particularly limited thereto as long as it is water in which the solids can be separated from water by flotation in a flotation tank. For example, the untreated water may be wastewater, and the wastewater may include domestic sewage, laundry wastewater, industrial wastewater, agricultural/livestock wastewater, or a combination thereof, as mentioned above. In addition, in the present disclosure, “treated water” refers to water resulting from separating solids from untreated water through a water treatment system provided in the present disclosure.

In this disclosure, “solids” refers to impurities that need be removed from water in order to purify wastewater and discharge it into a river or a sea. In this disclosure, “solids” may be used interchangeably with expressions such as “impurities”, “contaminants”, “insoluble particles”, and “floating particles”.

In this disclosure, the term “microbubble forming means” refers to a means or device capable of generating bubbles of the gas supplied into the flotation tank, which when filled with the water to be treated, forms bubbles in a suitable micron-size range, more suitably in a range up to about 0.1 mm (about 100 μm) size of bubbles (typically in the diameter size).

In this disclosure, when the microbubble forming means is positioned adjacent to the second part of the shell, the term “adjacent to” may be defined by arranging the microbubble forming means at a position where the shortest distance between the microbubble forming means and the second end of the shell is less than the shortest distance between the microbubble forming means and the second end of the tube.

In this disclosure, the terms “lower”, “upper” and “upward” are basically based on a longitudinal direction of the system in respect of the fluid stream regardless whether a system having a certain longitudinal shape is arranged in an upward/vertical orientation or in a horizontal orientation or in another orientation.

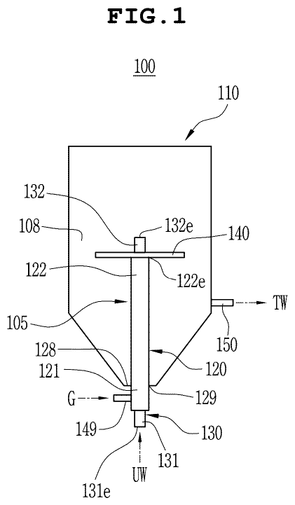

FIG. 1 is a schematic view illustrating a water treatment system 100 according to an embodiment of the present disclosure. The water treatment system comprises a flotation tank 110; a shell-tube inlet conduit comprising a shell 120 and at least one tube 130; a microbubble forming means 140; and a treated water outlet 150.

The flotation tank 110 has a predetermined internal space. As described later, the internal space may be filled with untreated water “UW” and a gas “G” supplied into the flotation tank 110. The gas G may be supplied inside the flotation tank 110 via gas inlet 149, shell 120, and microbubble forming means 140. Within the flotation tank 110, solids present in the untreated water UW may float upward and be separated from treated water TW.

In the present disclosure, the “shell-tube inlet conduit” 105 refers to an introduction part through which the untreated water UW and the gas G are independently introduced into the flotation tank 110. The shell-tube inlet conduit 105 comprises a first part being exposed to the outside of the flotation tank 110 and a second part extending inside the flotation tank 110. The shell-tube inlet conduit 105 comprises the shell 120 and the at least one tube 130, with the at least one tube 130 being disposed within the shell 120. The shell 120 may also be referred to as an outer tube or gas tube. The tube 130 may also referred to as an inner tube or untreated water tube. The shell 120 and the tube 130 may have the form of a shell and tube device wherein the tube is positioned within a shell tube. Specifically, the shell 120 is formed to surround the tube 130 leaving a space between an internal diameter of the shell 120 and an external diameter of the tube 130. In some embodiments where a shell-tube inlet conduit has one tube 130, the shell-tube inlet conduit may be interpreted as a double tube form comprising the tube 130 as an inner tube and a shell 120 as an outer tube. For example, the shell 120 and the tube 130 may each have a cylindrical shape, however, the embodiment is not limited in this way and many other configurations may be used. For example, the shell 120 and the tube 130 may be rectangular cross-section tubes, or oval cross-section tubes.

The shell 120 and the tube 130 of the shell-tube inlet conduit 105 may have independent flow paths. Specifically, in the present disclosure, gas G may flow through the shell 120 and the untreated water UW may flow through the tube 130. More specifically, the gas G may flow through the gap (or space) formed between an outer surface of the tube 130 and an inner surface of the shell 120. The untreated water UW may flow through the tube 130, i.e., through the space formed inside the tube 130.

The shell-tube inlet conduit 105 may be connected to the flotation tank 110. The shell-tube inlet conduit 105 may be positioned in an upright direction and may pass through an inlet opening 129 of the flotation tank. The shell 120 may be securely connected to the perimeter of the inlet opening 129. The tube 130 may be securely attached to the shell via any suitable means (NOT SHOWN) that do not substantially obstruct the flow path through the shell 120.

In the present disclosure, the water treatment system may be a bottom-up water treatment system meaning that in the system, the gas and the untreated water may be supplied to a lower part of the flotation tank 110 and flow upward. Specifically, the shell-tube inlet conduit may be connected to a lower end of the flotation tank 110. For example, the lower end may be a lower side surface or bottom surface 128 of the flotation tank 110. The flotation tank 110 according to the present disclosure may have a predetermined height. In the present disclosure, the “lower end” and “lower part” of the flotation tank 110 refers to an area located at equal to or less than 50%, specifically, equal to or less than 40%, more specifically, equal to or less than 30%, more specifically, equal to or less than 25%, and even more specifically, equal to or less than 20% of the height of the flotation tank 110 from the bottom of the flotation tank 110. In addition, the “connected” refers to a state in which an outer surface of the shell 120 and outer surface and inner surface of the flotation tank 110 are in contact with each other in the thickness direction of the flotation tank 110.

Referring again to FIG. 1, the shell 120 has a first part 121 exposed to the outside of the flotation tank 110 and a second part 122 extending into the flotation tank 110. The gas G may be supplied from the outside through the first part 121 exposed to the outside. The first part 121 of the shell 120 may comprise a gas inlet 149 through which the gas G is introduced from the outside to the shell 120 and through the shell 120 and the microbubble forming means 140 into the space 108 of the flotation tank 110.

The shell 120 may extend through an outer surface and an inner surface of the flotation tank 110 into the internal space 108 of the flotation tank 110. In some embodiments, the second part 122 of the shell 120 may extend from the bottom of the flotation tank 110 to a position corresponding to 20% to 50% from the bottom of the height of the flotation tank 110, specifically 20% to 40%, more specifically 25% to 35%, and most specifically 30%. In order to recover the treated water TW from the flotation tank 110 by separating it from the untreated water UW that is continuously introduced during actual operation of the water treatment system 100, the treated water TW may be recovered from the flotation tank 110 via a treated water outlet 150 which may be located at a position lower than the second end 122e of the shell 120.

The gas supplied into the flotation tank 110 through the shell 120 may be any suitable gas that is capable of readily generating microbubbles within the flotation tank 110 and which does not dissolve well in wastewater. For example, the gas may include air, oxygen, nitrogen, or a combination thereof.

In addition, referring to FIG. 1, the tube 130 may also have a first part 131 extending to the outside of the flotation tank 110 and a second part 132 extending inside the flotation tank 110. A first end 131e of the tube 130 may be exposed to the outside of the flotation tank 110 and may not be surrounded by the shell 120. A second end 132e of the tube 130 may be exposed to the inside of the flotation tank 110 and may not be surrounded by the shell 120. The untreated water UW may be supplied from the outside through the first end 131e of the tube 130 exposed to the outside. In an embodiment, the first end 131e of the tube 130 may comprise an untreated water inlet through which the untreated water is introduced from the outside.

The tube 130 may extend through the outer surface and the inner surface of the flotation tank 110 into the internal space 108 of the flotation tank 110. The part of the tube 130 extending inside the flotation tank is referred to as the second part 132 of the tube 130. In an embodiment, the second part 132 of the tube 130 may extend from the bottom of the flotation tank 110 to a position corresponding to at least 20% to 50% of the height of the flotation tank 110, specifically 20% to 40%, more specifically 25% to 35%, and most specifically 30% of the height of the flotation tank 110. In order to recover the treated water TW from the flotation tank 110 by separating it from the untreated water UW that is continuously introduced during actual operation of the water treatment system 100, the treated water TW may be recovered from the flotation tank 110 at a position lower than the second end 132e of the tube 130.

In addition, the solids in the untreated water TW introduced through the tube 130 may float through bubbles derived from the gas introduced through the shell 120. From the perspective of flotation efficiency of the solids, the position of the second end 132e of the tube 130 may be higher than that of the second end 122e of the shell 120.

The shell-tube inlet conduit 105 according to the present disclosure may comprise at least one tube 130. In an embodiment, the shell-tube inlet conduit may comprise at least two tubes 130. A plurality of tubes may be arranged within the shell 120 spaced apart from each other. The use of the plurality of tubes 130 may increase the dispersibility of the untreated water UW introduced into the flotation tank 110, thereby contributing to faster flotation of the solids.

In another embodiment, the shell-tube inlet conduit 105 may have one tube 130. Specifically, the shell-tube inlet conduit 105 may have one tube 130 and one shell 120 having cross sections that are concentric with each other. When one tube 130 is used, the gas may be relatively more densely packed in the circumference of the second end of the tube 130, thereby making it easier for microbubbles derived from the gas to form a so-called microbubble curtain. In this case, the shell and the tube may be coaxially aligned in a longitudinal direction. As a result, the use of one tube 130 may contribute to further increasing the purity of the treated water.

In one of the embodiments in which the shell-tube inlet conduit has one tube 130, the ratio of the diameter of the second part 132 of the tube 130 to the diameter of the second part 122 of the shell 120 may be in a range of 1:1.1 to 1:3. Specifically, the ratio may be in a range of 1:1.2 to 1:2.8, more specifically 1:1.2 to 1:2. When the ratio is less than the above-described range, a problem of reducing a flotation effect using microbubbles may arise, and also a problem of reducing the purity of the treated water may arise. When the ratio exceeds the above-described range, a problem of reducing economic efficiency may arise.

In this regard, a difference in supply rates of the gas and the untreated water may also affect the performance of the water treatment system. In an embodiment, the ratio of the inflow rate of the untreated water to the inflow rate of the gas may be in a range of 1:1 to 6:1, and specifically the ratio may be in a range of 1.5:1 to 3:1. When the ratio is less than the above-described range, a problem of reducing a flotation effect using microbubbles may arise, and also a problem of reducing the purity of the treated water may arise. When the ratio exceeds the above-described range, a problem of reducing economic efficiency may arise.

As described above, the shell 120 and the tube 130 provide independent flow paths for the gas and the untreated water, respectively. For this purpose, a predetermined separation distance may be maintained between the shell 120 and the tube 130. In an embodiment, the shell-tube inlet conduit may further comprise a support installed between the shell 120 and the tube 130 to maintain the separation distance therebetween.

The introduction part of this structure used in the water treatment system according to the present disclosure increases distribution of the gas around the untreated water introduced into the flotation tank 110, thereby making it possible to promote flotation of the solids in the untreated water regardless of the width and depth of the flotation tank 110.

The water treatment system according to the present disclosure further comprises the microbubble forming means 140. As illustrated in FIG. 1, the microbubble forming means 140 is positioned on the second end 122e of the shell 120 or adjacent to the second end 122e of the shell 120. The gas is released from the second end 122e of the shell 120 into the internal space of the flotation tank 110 and forms microbubbles by passing through the microbubble forming means 140. The microbubbles thus formed may form a gas curtain under the untreated water discharged from the second end 132e of the tube 130 into the internal space 108 of the flotation tank 110. The gas curtain may prevent sedimentation of the solids in the untreated water and promote flotation of the solids.

In an embodiment, the size of the microbubbles formed from the microbubble forming means 140 may be equal to or less than 100 μm. Specifically, the size of the microbubbles may be in the range of 1 to 100 μm such as 1 to 50 μm, more specifically 5 to 100 μm such as 5 to 50 μm, more specifically 10 to 100 μm such as 10 to 40 μm, and even more specifically 20 to 100 μm such as 20 to 40 μm. For example, the size of the microbubbles may be measured with a transient wet bubble/particle size analysis system. Through the synchronization of a high-speed camera and a nanosecond pulsed laser, said analysis system can image contaminant particles and/or bubbles present in a liquid, and analyze the size distribution and shape of the particles and/or bubbles. When the size of the microbubbles is equal to or less than 100 um, it is possible to float the solids by slowly moving them to a liquid surface in the flotation tank 110 compared to when the size is greater than 100 μm. In addition, the microbubbles have a relatively long bubble life of about 1 to 2 minutes and a larger surface area, which is advantageous in terms of flotation efficiency of the solids. When the size of the microbubbles exceeds the above range, the bubbles may rise too fast and cause a turbulent flow during rising which reduces significantly the flotation efficiency of the solids. On the other hand, when the size of the microbubbles is less than the above range, the bubbles may rise too slowly and stay in the water which also reduces the flotation efficiency of the solids.

In the present disclosure, the microbubble forming means 140 is not particularly limited and may be any suitable means provided it can be positioned adjacent to the second end 122e of the shell 120 and can form microbubbles having a size within the above range of 1 to 100 μm, more specifically 5 to 100 μm, more specifically 10 to 100 μm, and even more specifically 20 to 100 μm. For example, the microbubble forming means 140 may comprise a membrane diffuser, an electroflotation device, a shear flotation (SF) device, a pressurized flotation device, or a combination thereof. Specifically, the membrane diffuser may comprise an air flotation (AF)-ceramic membrane. In addition, the shear flotation (SF) device may comprise an SF-internal circulation device. In addition, the pressurized flotation device may comprise a dissolved air flotation (DAF)-pressurized tank type device and a DAF-pressurized pump type device.

The water treatment system according to the present disclosure may further comprise the treated water outlet 150. The treated water outlet 150 is connected to the flotation tank 110 and may discharge the treated water “TW” separated from the solids in the flotation tank 110 to the outside of the flotation tank 110. In order to recover the treated water TW from the flotation tank 110 by separating it from the untreated water that is continuously introduced during actual operation of the water treatment system, the treated water outlet 150 may be formed at a position lower than the second end 122e of the shell 120, the second end 132e of the tube 130, or the microbubble forming means 140. More specifically, the treated water outlet 150 may be connected to the flotation tank 110 at a position lower than the second end 122e of the shell 120, the second end 132e of the tube 130, and the microbubble forming means 140.

The outflow rate of the treated water TW discharged through the treated water outlet 150 may be controlled by considering the inflow rate of the introduced untreated water “UW”. In an embodiment, the outflow rate of the treated water TW discharged through the treated water outlet 150 may be equal to or less than the inflow rate of the untreated water UW introduced through the tube 130. The outflow rate of the treated water TW that is faster than the inflow rate of the untreated water may cause a problem of reducing the purity of the treated water.

The solids floating to the liquid surface in the flotation tank 110 together with the microbubbles may be recovered. In an embodiment, the water treatment system may further comprise a floating solid recovery means. In the present disclosure, the floating solid recovery means is not particularly limited. For example, the floating solid recovery means may comprise a skimmer designed to skim-off any solids moved to the surface of the water. Specifically, the air bubbles formed by the microbubble forming means 140 may cause the contaminant solids found in the untreated water UW to rise to the surface of the water, creating a layer of floating sludge. A mechanical skimmer, usually consisting of a rotating arm or conveyor, may then gently move across the surface of the water. The skimmer, for example, may push the floating sludge towards a collection trough or scraper. The collected sludge may then be removed from the system for further processing, disposal, or sometimes recovery, depending on the type of contaminant.

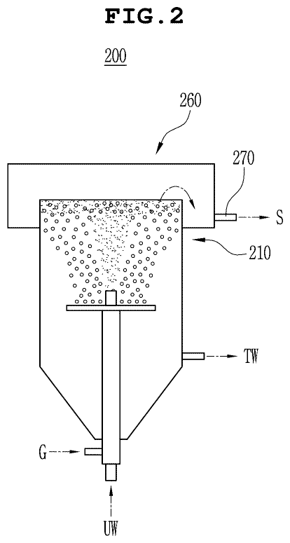

FIG. 2 is a schematic view illustrating a water treatment system 200 according to another embodiment of the present disclosure. For another example, as shown in FIG. 2, the floating solid recovery means may comprise an overflow chamber 260. The contaminant solids raised to the surface of the water by microbubbles overflow the flotation tank 210 with a continuous supply of untreated water UW. The overflowed solids are collected in the overflow chamber 260. In an embodiment, the diameter of the overflow chamber 260 can be 2-4 times larger than the diameter of the flotation tank 210. Further, the height of the overflow chamber 260 may be ⅕ to ½ times the height of the flotation tank 210.

In an embodiment, the flotation tank 110 may comprise a floating solid outlet (not shown). The floating solid outlet may be positioned at an upper end of the flotation tank 110. More specifically, the floating solid outlet may be formed a position higher than the second end 122e of the shell 120, the second end 132e of the tube 130, and/or the microbubble forming means 140.

In another embodiment, as shown in FIG. 2, the floating solid recovery means may further comprise a floating solid outlet 270. The collected solids S in the overflow chamber 260 may be discharged to the outside through the floating solid outlet 270.

The water treatment system according to the present disclosure as described above has a simple structure compared to conventional water treatment systems, thereby achieving size reduction and providing easier wastewater treatment.

Although the embodiments of the present disclosure have been disclosed for illustrative purposes, those skilled in the art will appreciate that various modifications, additions, and substitutions are possible, without departing from the scope and technical concepts of the present disclosure as disclosed in the accompanying claims. Furthermore, the embodiments may be combined to form additional embodiments.

What is claimed is:

1. A water treatment system, comprising:
a flotation tank;
a shell-tube inlet conduit connected to the flotation tank and comprising a shell configured to supply a gas and at least one tube configured to supply untreated water, wherein each of the shell and the tube has a first part exposed to an outside of the flotation tank and a second part extending into the flotation tank;
a microbubble forming means positioned on or adjacent to the second part of the shell; and
a treated water outlet connected to the flotation tank and configured to allow treated water separated from solids in the flotation tank to be discharged therethrough.

2. The water treatment system of claim 1, wherein the flotation tank has a predetermined height,
the shell-tube inlet conduit is connected to a lower part of the flotation tank, and
the second part of each of the shell and the tube extend from a bottom of the flotation tank to a position corresponding to at least 25% from the bottom of the height of the flotation tank.

3. The water treatment system of claim 1, wherein the at least one tube is a single tube.

4. The water treatment system of claim 1, wherein the shell-tube inlet conduit further comprises a support installed between the shell and the at least one tube and configured to hold the at least one tube and maintain a separation distance therebetween.

5. The water treatment system of claim 1, wherein a ratio of a diameter of the second part of the tube to a diameter of the second part of the shell is in a range of 1:1.1 to 1:3.

6. The water treatment system of claim 1, wherein the position of the second end of the tube is higher than that of the second end of the shell.

7. The water treatment system of claim 1, wherein the microbubble forming means is positioned on the second part of the shell or adjacent to the second part of the shell.

8. The water treatment system of claim 1, wherein the microbubble forming means comprises a membrane diffuser, an electroflotation device, a shear flotation (SF) device, a pressurized flotation device, or a combination thereof.

9. The water treatment system of claim 1, wherein the treated water outlet is formed at a position lower than the second end of the shell, the second end of the tube, or the microbubble forming means.

10. The water treatment system of claim 1, further comprising:
a floating solid recovery means.

11. A method to treat water using the water treatment system according to claim 1.

12. The method of claim 11, comprising:
introducing untreated water into the flotation tank through the tube;
supplying gas through the shell from the outside into the flotation tank;
forming microbubbles by passing the gas through the microbubble forming means; and
discharging the treated water to the outside of the flotation tank.

13. The method of claim 11, wherein a ratio of an inflow rate of the untreated water to an inflow rate of the gas is in a range of 1:1 to 6:1.

14. The method of claim 11, wherein a size of microbubbles formed from the microbubble forming means is equal to or less than 100 μm.

15. The method of claim 11, wherein an outflow rate of the treated water discharged through the treated water outlet is equal to or less than an inflow rate of the untreated water introduced through the tube.
